(19) United States
(12) Patent Application Publication
(10) Pub. No.: US 2007/0136243 A1
(43) Pub. Date: Jun. 14, 2007

(54) System and method for data indexing and retrieval

(76) Inventor: Markus Schorn, Seekirchen (AT)

Correspondence Address: FAY KAPLUN & MARCIN, LLP, 15O BROADWAY, SUITE 702, NEW YORK, NY, 10038, US

(21) Appl. No.: 11/301,161

(22) Filed: Dec. 12, 2005

(51) Int. Cl. G06F 17/30

(52) U.S. Cl. 707/3

(57) ABSTRACT

Described is a system and method to create an index for a plurality of documents, the index including hash codes corresponding to each word in the plurality of documents, wherein each hash code corresponds to one or more of the plurality of documents, receive a query including a search word, create a search hash code from the search word, compare the search hash code to the hash codes in the index and return the one or more of the plurality of documents corresponding to one of the hash codes matching the search hash code.

### BACKGROUND INFORMATION

Users may frequently desire to search a computer database for particular files included therein. The files may be located based upon an occurrence of a word and/or phrase specified by the user. That is, the user may enter a search term, and the files which are most relevant to the search term may be located and/or retrieved. Initially, text searching was performed by skilled indexers, who assigned to each file a keyword, which represented the subject matter thereof. The indexers then stored the keywords and a reference to the document in the computer database, thereby allowing the user to retrieve documents to which keywords had been attached.

More modern search techniques include full text searching, where an entire text of each file is stored in the database. The full text search technique is most commonly supported by an index, which references every file in the database. An entry may be created in the index for each word of each file, usually upon creation of the file or shortly thereafter. The entry may include an exact position of every occurrence of the word. Therefore, when the user enters a query comprising a particular word or phrase, the files in which the word/phrase occurs may be retrieved without scanning each file.

Unfortunately, generation of the index and searching may consume a relatively significant amount of time. In conventional indexing, each word of each file is associated with a unique identifier, which is stored in the index. The association typically occurs by conversion of the word into a different form and assignment of the identifier to the word. Accordingly, the query entered by the user must be retrieved by locating the identifier(s) in the index, which further points to relevant text in the database. Although this indexing technique may be seen to reduce an amount of storage space occupied by the index, it also slows performance of a search and thus the user must wait for results.

### SUMMARY OF THE INVENTION

A method to create an index for a plurality of documents, the index including hash codes corresponding to each word in the plurality of documents, wherein each hash code corresponds to one or more of the plurality of documents, receive a query including a search word, create a search hash code from the search word, compare the search hash code to the hash codes in the index and return the one or more of the plurality of documents corresponding to one of the hash codes matching the search hash code.

A system having an index for at least one document, the index including hash codes corresponding to each word in the at least one document; wherein each hash code corresponds to one or more of the documents, a query module for receiving a query, the query including one or more search words, a hash code module for creating a search hash code from each search word, a comparison module for comparing the search hash code to the hash codes in the index and a return utility configured to return one or more of the documents corresponding to one of the hash codes matching the search hash code.

A system comprising a memory storing a set of instructions and a processor to execute the instructions. The set of instructions being operable to create an index for a plurality of documents, the index including hash codes corresponding to each word in the plurality of documents; wherein each hash code corresponds to one or more of the plurality of documents, receive a query including a search word, create a search hash code from the search word, compare the search hash code to the hash codes in the index and return the one or more of the plurality of documents corresponding to one of the hash codes matching the search hash code.

### BRIEF DESCRIPTION OF THE DRAWINGS

FIG. 1 is a diagram showing a representation of an exemplary retrieval system according to the present invention.

FIG. 2 shows an exemplary method for updating an index according to the present invention.

FIG. 3 shows an exemplary method for performing an indexed search according to the present invention.

FIG. 4 shows an exemplary file table according to the present invention.

FIG. 5 shows an exemplary word file according to the present invention.

FIG. 6 shows an exemplary content file according to the present invention.

### DETAILED DESCRIPTION

The present invention may be further understood with reference to the following description of.preferred exemplary embodiments and the related appended drawings, wherein like elements are provided with the same reference numerals. The present invention is related to systems and methods for indexing and retrieving data, for example, within text documents. More specifically, the present invention is related to methods and systems for reducing a time spent in indexing and performing searches for words in text-documents. As described herein with respect to embodiments of the present invention, a “word” should be construed rather broadly. For example, a word may be any combinations of letters, numbers, hyphens, special characters, etc.

In a conventional indexing procedure, words of the text are each associated with a unique identifier, which may then be stored in an index. Thus, when a user enters a query, in an attempt to search for a particular word, fragment, and/or phrase, the query is also associated with one or more identifiers. The index may be consulted to find a match for each identifier, and thus a location of the words, fragments, and/or phrases included in the query is determined. Thus, the corresponding files may be retrieved. However, this indexing procedure may consume excessive memory space and time by storing and indexing the unique identifiers.

According to the present invention, an index may be generated more quickly, may consume less memory, and may ultimately enable faster text searches. In an embodiment of the present invention, hash-codes of the words found in text documents are stored in the index, thereby decreasing a size of the index. That is, because an identifier for each word need not be managed, all words may be stored in a set of files, which saves memory space. Additionally, an appreciable amount of time is saved during generation of the index. Specifically, the index may contain a vast number of words, and thus eliminating a need to look up the identifier for each word saves a great deal of time. Further, because the identifier need not be accessed in order to retrieve the desired search term, the search may be performed faster. Time may also be saved due to a decreased number of files to be searched.

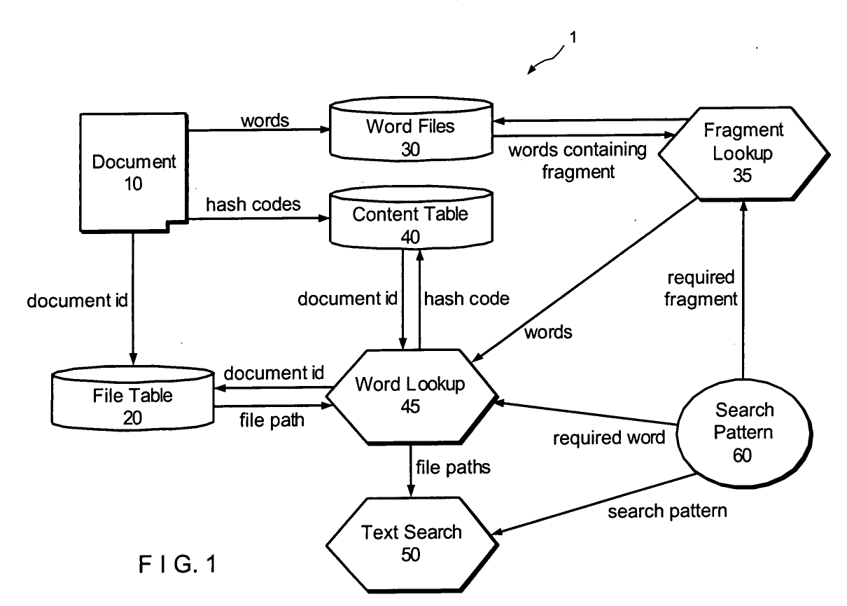

FIG. 1 shows a diagram of an exemplary retrieval system 1 according to the present invention. The retrieval system 1 may include an indexing system and a searching system. The indexing system may include one or more databases in which information relating to each document 10 is stored. The searching system may include components necessary to execute fragment lookups, word lookups, and/or text searches.

As shown in FIG. 1, the indexing system includes a File Table 20, Word Files 30, and a Content Table 40. The File Table 20 may be used to store a reference or identifier of each of the documents 10 that may be searched. Because an identifier of the document 10 is stored, as opposed to an entire text, a significant amount of memory is saved, and thus a greater number of documents 10 may be stored. The File Table 20 may also store a location (e.g., a file path) of each document 10.

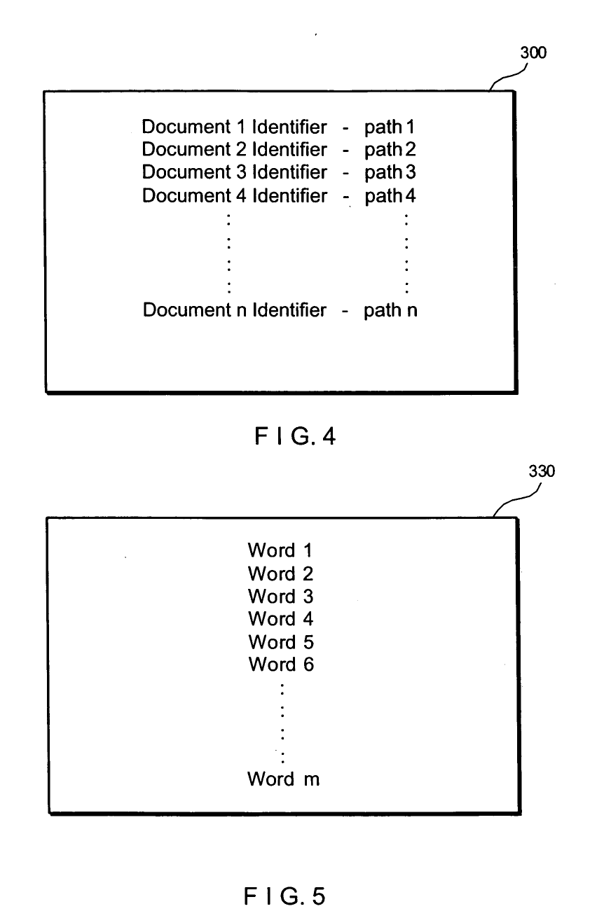

FIG. 4 shows an exemplary file table 300 according to the present invention. In this example, the file table 300 is storing an identifier for documents 1 through n. Those of skill in the art will understand that there are many manners of providing identifiers for a specific document and the exemplary embodiments of the present invention may be used with any of these manners. The reference to the identifier for each stored document also includes a file path for the document. Thus, if a document is identified through a search (described in greater detail below), the system may then retrieve the actual document using file path stored in the file table 300. Those of skill in the art will also understand that the actual file format for storing the file table 300 may vary. For example, the file table 300 may be stored in the format of a table, a data array, a database, etc.

Each word of the documents 10 may be stored in one or more files, for example, the Word Files 30. The Word Files 30 may be a set of files (e.g., text files, database, files, etc.) containing a sorted list of words separated by a character. The files may be merged when they are growing, thus providing for efficient maintenance. For example, if words from a document 10 are being written to a file, and the file becomes too large, the file is merged with an existing file of approximately equal size. Thus, one larger file is created from the joinder of the two smaller ones. This joinder of multiple files is very efficient because the exemplary embodiments of the present invention provide for the elimination of the unique identifiers for each of the words. In a preferred embodiment of the present invention, some words may be excluded from the Word Files 30. For example, “stop words” may be excluded, because a search for any or all of these words would likely result in a match in every document 10. Accordingly, words such as “a,” “of,” “and,” “the,” “I,” “it,” and “you”may not be indexed. If a word occurs multiple times within a document 10, or if it occurs within more than one document 10, the words need only be written to the Word Files 30 once. Thus, the file(s) is much smaller than a database containing all the words and unique identifiers for the words from the documents 10 in their entirety. This also allows the substring search (described in greater detail below) to be faster because the Word Files 30 are smaller than the corresponding databases in the prior art.

According to an embodiment of the present invention, a search containing a given substring may be performed quickly and efficiently. Because a substring search may require a search of a full file, a time for performing the search may be decreased in proportion to a decreased size of the file. According to an embodiment of the present invention, the Word Files 30 are smaller than the corresponding databases in the prior art because only one character may separate the words, as opposed to an identifier. Thus, the search may be performed with a maximum quickness exclusive of more expensive preparation.

FIG. 5 shows an exemplary word file 330 according to the present invention. In this example, the word file 330 is storing the words 1 through m contained in each of the documents 1 through n as shown in file table 300 of FIG. 4. As described above, the word file 330 will include all the words extracted from the documents to be searched. However, as shown by the exemplary file 330, the words only are stored. There is no reference to unique identifiers for the words, thereby reducing the size of the word file 330. In addition, other space saving measures may also be employed when building word file 330 such as eliminating stop words and only storing repeated words a single time. Thus, at the completion of the build, the word file 330 should contain a single instance of every word that is included in the documents to be searched. Also, as described above, the word file 330 may have been created by combining two or more other word files (not shown) into a single word file 330.

Hash-codes of every word in the document 10 may be stored in another database, such as Content Table 40. Hash-codes for each word in the document 10 may be generated using any of a number of hashing algorithms (e.g., MD5, SHAL, etc.). A method for computing hash-codes may be built into a text search engine. For example, the text search engine may be written in Java, and thus may utilize a built-in Java method for computing a hash code. Any built-in method may be used to compute the hash codes for the words in the documents 10. The Content Table 40 may also store an indication of which documents the various hash-codes are located within. For example, a table entry corresponding to a particular hash-code may contain the document identifiers of the documents 10 in which the un-hashed word occurs.

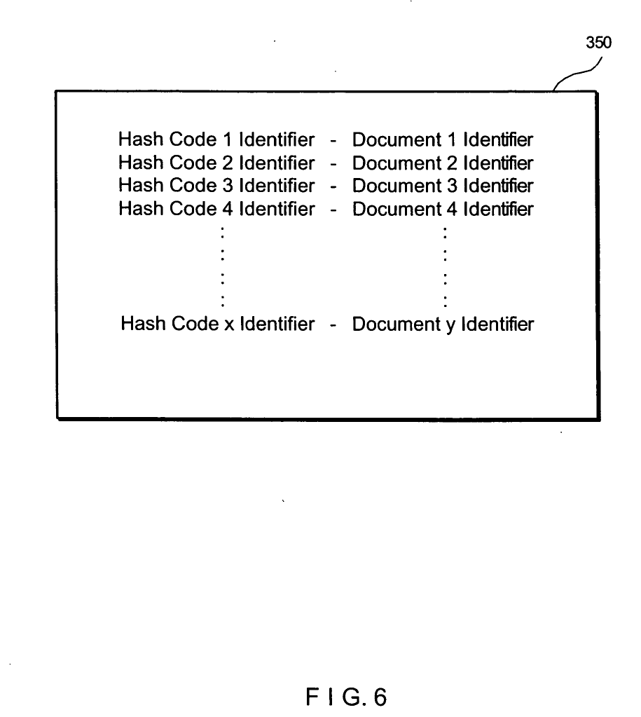

FIG. 6 shows an exemplary content table 350 according to the present invention. In this example, the content table 350 is storing hash codes for the words 1 through x contained in each of the documents 1 through n as shown in file table 300 of FIG. 4. As described above, the content table 350 will include the hash codes for all the words in the documents 1 through n and a reference to the document identifier for each document in which the particular hash code appears. For example, the hash code 1 for a particular word is shown as corresponding to the document 2 identifier, indicating that the word corresponding to the hash code 1 is contained in the document corresponding to the document 2 identifier. Thus, as will be described in greater detail below, when the content table 350 is searched for hash code 1, it may return the document 2 identifier. This identifier may then be used in conjunction with the file table 300 to find the path and retrieve the document.

The content table 350 also shows that a single hash code may appear in multiple documents, e.g., the same word appears in multiple documents. In this example, hash code 4 identifies two (2) separate document identifiers, document 3 identifier and document 4 identifier. Thus, the word corresponding to hash code 4 appears in the documents corresponding to the document 3 identifier and the document 4 identifier. In theory, the number of hash codes x in the content table 350 may be equivalent to the number of words in the word file 330. However, in practice, there may be some differences. For example, hash codes may be repeated for different words, as discussed in greater detail below. Further, a situation may occur after a period of time where the number of words in the word file 330 ceases to grow, because all words have already been used. However, the content table 350 will continue to map the hash-codes to new document identifiers as new documents are created. It is preferable that the same hashing algorithm be used to create hash codes for each word of all the documents to be searched.

The search system of the retrieval system 1 may also include several components. For example, as shown in FIG. 1, the search system may include a Fragment Lookup 35, a Word Lookup 45, and a Text Search 50. Each component may be used separately to perform its function, or two or more components may operate in conjunction. A determination of which component(s) is to be used may depend on a type of search, i.e., a Search Pattern 60, to be executed.

In entering a query, a user may attempt to search for text within one or more documents 10. There are several ways in which the user may format the query. For example, the user may enter only a fragment of a word, one or more entire words, a phrase, or a combination thereof. Depending on the contents of the query, and thus the Search Pattern 60, a searching procedure may be executed.

If the query contains a word, the system 1 will perform a Word Lookup 45. The Word Lookup 45 computes the hash-code of the word entered in the user's query, which may then be used to locate relevant documents 10. The Word Lookup 45 consults the Content Table 40 to find the entry that matches the computed hash-code. As described above, this entry in the Content Table 40 also provides the document identifiers of the documents 10 in which the queried word occurs. Because an identifier for the queried word need not be looked up before the document identifier is retrieved, a considerable amount of time is saved. Once the document identifier is obtained, the system 1 may consult the File Table 20 to determine the location(s) of the relevant document(s) and retrieve the documents. The system 1 may then perform a subsequent Text Search 50 within the retrieved documents to prove a presence of the word, as discussed below.

If the query contains a word fragment, the system 1 will perform a Fragment Lookup 35. In the Fragment Lookup 35, the Word Files 30 may be consulted to find each word that contains the fragment. For example, a query for a fragment “regist” may return any or all of the words “register,” “registers,” “registering,” “registration,” “registrar,” etc. As described above, the Word Files 30 is designed to contain a single instance of every word from the documents 10. Thus, these words may only be returned if they occur at least once within one of the documents 10. Once the words containing the fragment are found, the Fragment Lookup 35 may pass the set of words returned from the Word Files 30 search to the Word Lookup 45, which will perform the same routine as described above. That is, the Word Lookup 45 will search the Content Table 40 for the hash codes corresponding to each of the set of words returned from the Word Files 30 search.

If the query contains a phrase or specifies a sequence of occurrence for search terms, the system 1 may perform a Text Search 50. The document(s) 10 containing each of the words in the query are retrieved using the procedures described above for the Fragment Lookup 35 and/or the Word Lookup 45. Once the subset of documents 10 containing each of the words in the query have been retrieved, the system 1 may search through this subset to find only those containing the sequence specified in the query. Thus, fewer documents 10 must be searched in order to find the sequence. Accordingly, the search may be executed quickly and efficiently. The Text Search 50 may also be performed in order to locate several words within a predefined proximity of one another, although they may not be immediately juxtaposed as in a phrase.

If the query contains a combination of words, fragments, and/or phrases, several search procedures may be executed. For example, the Fragment Lookup 35 may be used to retrieve documents 10 matching a portion of the query, whereas the Word Lookup 45 may be used to retrieve documents 10 matching another portion. The Text Search 50 may then be used to search the retrieved documents 10 and return those which contain all fragments, words, and phrases included in the query. Thus, as opposed to searching an entire database for a document which contains the entire query, fewer documents 10 may be searched.

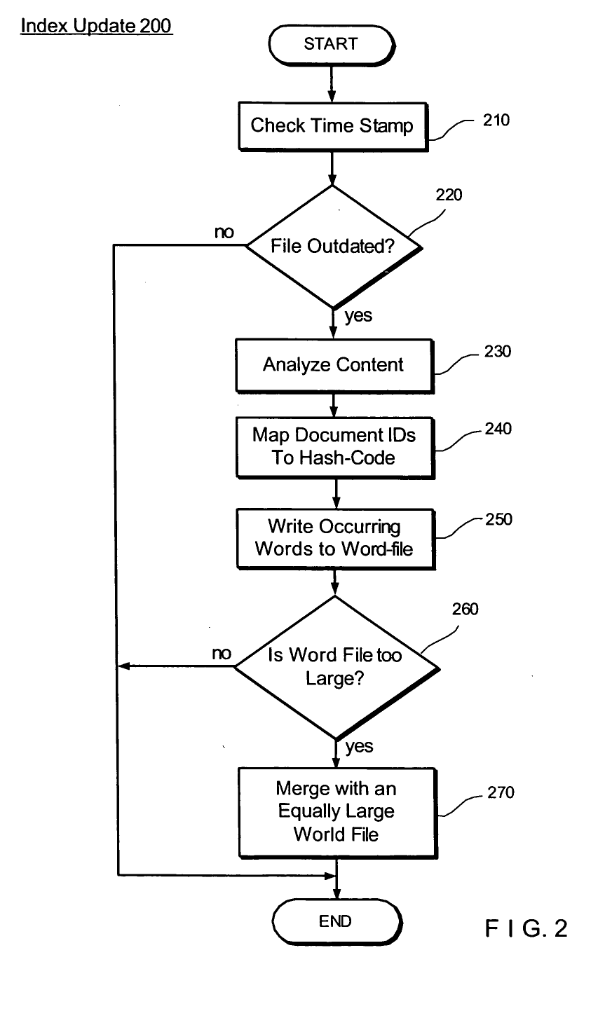

FIG. 2 shows an exemplary method 200 for updating an index according to the present invention. The method 200 will be described with reference to the retrieval system 1 of FIG. 1. However, it will be understood by those of skill in the art that various alternative systems may be used to implement the method 200. In addition, the method 200 is described with reference to one exemplary document. Those of skill in the art will understand that the method 200 may be performed for each document that is to be searched.

In step 210, the indexing system checks a timestamp of each file in a database. The timestamp may relate to a current time, a time of creation of the index, and/or a time of previous update. For example, in one embodiment of the present invention, the indexing system may compare the current time with a timestamp issued upon creation of the index. In another embodiment, the indexing system may compare the current time with a timestamp issued at a most recent index update. In yet another embodiment, the indexing system may compare the timestamp issued at a time of a most recent file update with a timestamp issued at the most recent index update. The indexing system may use the information obtained in step 210 to determine whether the file is outdated (step 220). The system administrator or controller of the documents may set time parameters that determine if the index is outdated. These parameters may be individual to the particular system.

If it is determined that the index for the file is outdated, the indexing system may analyze the content of the file (step 230). For example, the indexing system may compute a hash-code for each word. Once computed, the hash-codes may be mapped to document identifiers (step 240). The map may be stored in a database table, such as the Content Table 40 of FIG. 1. The Content Table 40 may also include an index of the hash-codes. The Content Table 40 may then be handled, while words which occur within the file are written to a Word File (step 250). If it is determined in step 260 that the Word File is too large, it may be merged with an equally large Word File in step 270. Despite a merger of the files as they become larger, a resulting size of the files is still much smaller than a size of a table containing each word and its corresponding identifier. Specifically, the word file resulting from the merger is approximately half the size of the table that includes unique identifiers for the words.

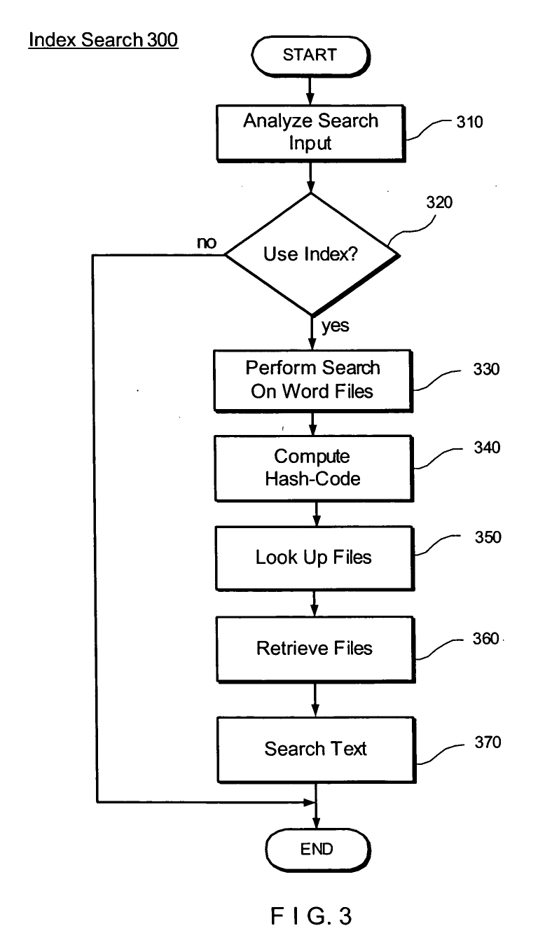

FIG. 3 shows an exemplary embodiment of a method 300 for performing an indexed search. The method 300 will also be described with respect to the retrieval system 1 of FIG. 1, although it should be understood that systems of various structures may adequately execute the method 300.

In performing a search, the user may attempt to search through one or a plurality of documents 10. For example, the exemplary embodiments of the present invention may be used to aid a computer programmer to search through one document 10 containing innumerable lines of code. In this case, the reference to a document identifier may not be to a particular document, but to a portion of a large document, e.g., a function, procedure, block of code, etc. Alternatively or additionally, the computer programmer may attempt to search through a database containing several such documents 10. In another embodiment of the present invention, the method 300 may be executed in order to perform an internet-based search to retrieve one or more web pages. Regardless of the basis of the search, the user may effect the search by entering a query.

In step 310, the system analyzes contents of the query to distinguish critical words and/or fragments. That is, the system finds which search terms must be present in a retrieved file in order to be considered a match. In one embodiment, the query may include a simple boolean text search. For example, the query may include one or more words joined by one or more operands, which identify a relationship desired to exist between the words it joins. In another embodiment, the query may include a natural language expression. For example, if the user performed a web-based search by entering a query such as “What are several restaurants in New York that serve Italian food” the system may identify “restaurants,” “New York,” and “Italian” as the critical words.

In step 320, the system determines whether it is appropriate to use an index. In some instances, using the index may be superfluous, because all text files will have to be considered as containing a potential match. For example, if the search input consists solely of stop words, none of the words may be deemed as critical. Using the index may also be superfluous if the queried word would occur in every document 10 in the search base due to a nature of the search base. For example, if the user attempts to search a database of text files related to mathematical calculations, a query for “equals” may produce a match in every file.

If it is determined in step 320 that an index should be used, the system continues performing the indexing search. Execution of each search may vary slightly depending on the particular Search Pattern 60. For example, as mentioned above, the query may consist of words, fragments, phrases, or a combination thereof. For each different Search Pattern 60, a lookup procedure may vary. Therefore, the performance of the lookup procedure will be described generally, with references to the variations which may occur depending on the Search Pattern 60.

In step 330, the system 1 performs a search on the Word Files 30. This search may only be required in performing a Fragment Lookup 35. Thus, the system 1 retrieves every word in the Word Files 30 that contains the fragment, and these words may be the critical words used in the Word Lookup 45. It should be noted that the words written to the Word Files 30 are only those words that occur within one or more of the documents 10. Therefore, although some words which contain the fragment may generally exist, they may not exist within the Word Files 30. Thus, the search may ultimately be narrowed because fewer critical words are sought.

In step 340, the system computes hash-codes for the critical words. The hash-codes may be computed by any of a variety of algorithms, although it is preferable to use the same algorithm as used in the generation and updating of the index. The hash-codes may then be used to look up the documents 10 in which the corresponding critical words occur (step 350). For example, in performing a Word Lookup 45, the Content Table 40 may be consulted. Because the Content Table 40 contains the hash-codes of each word in the indexed documents 10, along with the location information (e.g., document identifier, line and column number within the documents 10, etc.) relating to the words, the documents 10 matching the query may be identified.

In step 360, the documents 10 which were identified in step 350 may be retrieved from their respective locations. For example, using the location information obtained from the Content Table 40, the File Table 20 may be consulted. Because the File Table 20 includes address information for each document 10, the identified documents may be retrieved.

Once the documents 10 are retrieved, the Text Search 50 may be performed (step 370). The Text Search 50 may determine whether a match exists between the query and the word(s) in the documents 10. The Text Search 50 may also identify specified patterns (e.g., a specified number of occurrences of a critical word, occurrence of two critical words within a specified proximity, etc.) within the documents 10. The basis for the Text Search 50 is narrowed, because only the documents 10 retrieved in step 360 are searched. Thus, a time of execution of the search may ultimately be reduced.

The Text Search 50 may also serve as a check to determine that the search words are actually included in the documents that are returned. For example, a possibility exists that the hash-codes for two different words will be identical, thereby resulting in a collision. In the event of a collision, an increased number of matches may be found within the index. For example, during a Word Lookup 45, the hash-code computed for a critical word may be the same as the hash-code for another word. Thus, document identifiers of documents 10 containing both words may be retrieved from the Content Table 40. However, although a greater number of documents 10 may be retrieved in a collision, false results are not produced because the Text Search 50 produces only the documents 10 which match the query.

Performance of the indexing and retrieval system of the present invention was tested in comparison to a typical free-ware text search engine, which was tuned so that an incremental update would not use more than twice an amount of disk space needed for an initial index. Both systems were used to index linux kernel source code. Results yielded from this test proved that the system of the present invention was both faster and more efficient than the typical search engine. Specifically, the system of the present invention, which created an index in 91 seconds, was able to do so 30% faster than the typical search engine, which took 145 seconds. Further, the present invention only used 43 Mb of memory, whereas the typical search engine uses up to 74 Mb. Lastly, repeated test searches proved that the system of the present invention can satisfy a query for a word fragment twice as fast as the typical system. For example, where the system of the present invention was able to complete a search for word fragments within 330-350 ms, the typical search engine required between 850-1350 ms.

The present invention may greatly benefit users writing computer code. Code, such as source code, may be rather lengthy. For example, the source code required to execute a fairly basic application may be thousands of lines in length. Thus, if the user desires to modify particular portions of the text, locating those portions may be time consuming and frustrating. The present invention, however, allows the user to quickly and easily locate the desired text. As the user enters code, an index is created using hash-codes of each word. Accordingly, the user may perform a search for the desired text, whereby the index is consulted and a result is returned with increased speed as compared to a conventional indexing and searching system.

It will be apparent to those skilled in the art that various modifications may be made in the present invention, without departing from the spirit or scope thereof. Thus, it is intended that the present invention cover the modifications and variations of this invention provided they come within the scope of the appended claims and their equivalents.

1. A method of selecting documents from among a plurality of documents, comprising:
creating an index for the plurality of documents, the index including hash codes corresponding to each word in the plurality of documents; wherein each hash code corresponds to one or more of the plurality of documents;
receiving a query including a search word;
creating a search hash code from the search word;
comparing the search hash code to the hash codes in the index;
returning the one or more of the plurality of documents corresponding to one of the hash codes matching the search hash code; and
verifying that the one or more of the plurality of documents corresponding to one of the hash codes matching the search hash code contains the search word.

2. (canceled)

3. The method of claim 1, wherein the query includes one of a natural language expression and a boolean expression.

4. The method of claim 3, further comprising:
identifying one or more search words within the expression.

5. The method of claim 1, further comprising:
creating a file including an instance of each word in the plurality of documents.

6. The method of claim 5, wherein the search word includes a word fragment, the method further comprising:
retrieving one or more words corresponding to the word fragment from the file, and creating the search hash codes from the one or more retrieved words.

7. The method of claim 1, wherein the query includes additional search parameters, the method further comprising:
searching through the one or more of the plurality of documents corresponding to the hash codes matching the search hash code to satisfy the additional search parameters.

8. A method of selecting a document from among a plurality of documents comprising:
creating an index for the document, the index including hash codes corresponding to each word in the document; wherein each hash code is mapped to one or more portions of the document;
receiving a query including as each word;
creating a search hash code from the search word;
comparing the search hash code to the hash codes in the index;
returning the one or more portions of the document mapped to one of the hash codes matching the search hash code; and
verifying that the one or more portions of the document corresponding to one of the hash codes matching the search hash code contains the search word.

9. The method of claim 8, wherein the document is one of a computer program and a text file.

10. The method of claim 8, wherein the portion of the document is one of a function, a block of code and a procedure.

11. The method of claim 8, further comprising:
updating index, wherein the updating is performed automatically as one of a function of time and a function of changes in the document.

12. A system, comprising:
an index for at least one document, the index including hash codes corresponding to each word in the at least one document; wherein each hash code corresponds to one or more of the documents;
a query module for receiving a query, the query including one or more search words;
a hash code module for creating a search hash code from each search word;
a comparison module for comparing the sea hash code to the hash codes in the index;
a return utility configured to return one or more of the documents corresponding to one of the hash codes matching the search hash code; and
a verification module for verifying that the one or more of the documents corresponding to one of the hash codes matching the search hash code contains the search word.

13. The system of claim 12, wherein the query includes one of a natural language expression and a boolean expression.

14. The system of claim 12, further comprising:
a word file including an instance of each word in the document.

15. The system of claim 14, wherein the search word includes a word fragment and one or more words from the word file corresponding to the word fragment are retrieved, wherein the hash code modules creates the search hash codes for the one or more words retrieved from the word file.

16. The system of claim 12, further comprising:
a file table including a document identifier and a location of the document, wherein the index includes a document identifier mapped to the hash codes and returns the document identifier to the file table so the file table returns the location.

17. The system of claim 12, wherein the document is one of a computer program and a test file.

18. A system comprising a memory storing a set of instructions and a processor to execute the instructions, wherein the set of instructions are operable to:
create an index for a plurality of documents, the index including hash codes corresponding to each word in the plurality of documents; wherein each hash code corresponds to one or more of the plurality of documents;
receive a query including a search word;
create a search hash code from the search word;
compare the search hash codes to the hash codes in the index;
return the one or more of the plurality of documents corresponding to one of the hash codes matching the search hash code; and
verify that the one or more of the plurality of documents corresponding to one of the hash codes matching the search hash code contains the search word.
